(19) United States
(12) Patent Application Publication
(10) Pub. No.: US 2011/0191583 A1
(43) Pub. Date: Aug. 4, 2011

(54) Methods For Upgrading Software Or Updating Contents In Terminal Devices Based On Digital TV Data Broadcast

(76) Inventor: Yining Liu, Shenzhen (CN)

(21) Appl. No.: 12/297,944

(22) PCT Filed: Apr. 23, 2007
(86) PCT No.: PCT/CN2007/001341

§ 371 Date: May 5, 2010

(30) Foreign Application Priority Data
Apr. 21, 2006 (CN) 200610060467.0

(51) Int. Cl. G06F 9/44; G06F 12/14

(52) U.S. Cl. 713/165; 717/173

(57) ABSTRACT

A method for upgrading software or contents in a terminal device based on digital TV data broadcasting is provided. The method comprises steps of uploading an upgrading file or content file to an access gateway by a service provider via a data broadcasting system; transmitting the upgrading file or content file to the terminal device in a broadcast mode by the data broadcasting system; and receiving the transmitted upgrading file or content file by the terminal device. The method further comprises a step of determining whether the received upgrading file or content file is of a higher version than that of a currently used software file or content file of the terminal device; and if yes, upgrading the currently used software file or content file. The method according to the present invention decreases maintenance cost of the terminal device, facilitates upgrading system in time, maintains copyright benefit of the service provider, and is convenient for the user to upgrade his terminal device.

### TECHNICAL FIELD

This invention refers to a technology for a TV system, more particularly, to a method for upgrading software in a terminal device in a digital TV system.

### BACKGROUND OF THE INVENTION

Digital TV broadcast systems are all-digital end-to-end systems, which convert conventional analog TV signals into binary digital signals by sampling, quantizing and encoding the conventional analog TV signals. Then, the converted signals can be processed, transported, recorded, stored, monitored and controlled in the systems. The systems comprise ground, wired and satellite broadcast systems, each of which has different transmitting networks from the others. FIG. 1 shows a transmitting network for ground broadcast systems. Signals are transmitted in the form of radio wave via antennas in TV stations. A user within an antenna overlay area may obtain TV programs by using a receiving antenna and a TV set.

Currently, there are various kinds of digital TV receiving terminals comprising digital TV receivers, digital TV receiving set-top boxes, in-vehicle TV receivers, portable TV receivers and so on. Since the cost for enhancing or improving functions of the receiving terminals by replacing the receiving terminals is very high, there is a need of enhancing or improving functions of the receiving terminals by upgrading the software running therein. For example, E-maps in a TV receiving terminal with a function of GPS navigation are required to be upgraded frequently as road conditions change. Therefore, the receiving terminals which cannot be adapted to upgrade the software running therein would be disused in the future.

The currently popular means for upgrading the software are described hereinafter.

### Upgrading by Using FLASH Welding and Burning

In this method, a FLASH storage is taken out from the TV receiving terminal, updated by using a specific burning and recording device, and then mounted back in the TV receiving terminal. However, once the upgrading is failed, the FLASH storage should be retaken out to be upgraded again. Thus, this method is complicated, low-security, costly and inefficient.

### B. Upgrading by Using External Ports in Receiving Terminals and Memories for Copying Files

In this method, users should be aware of the release of the latest version of software to be updated so as to obtain the required upgrading files. In addition, the terminals' manufacturer provided the users with the required upgrading files in form of an optical disc or another storage medium. Therefore, this method is costly and inconvenient.

### C. On-Line Upgrading

In this method, the receiving terminal is provided with a network access port, which increases the cost. Moreover, in the case of using ADSL network, the transmission rate in a user end is around 2.5 Mbps, and in the case of using wireless network such as GPRS or CDMA, the transmission rate in the user end is generally less than 100 Kbps. Therefore, it is hard to download mass data files such as the upgrading files for E-maps. In addition, since the websites providing the upgrading files generally take a point-to-multipoint transport scheme, the networks for the websites may be congested when a plurality of users download the files from the websites at the same time.

Furthermore, when using the conventional methods to obtain the upgrading files from providers, the upgrading files will be spread illegally, which goes against protection of digital copyrights.

A new method for upgrading software in the TV receiving terminal is based on a digital TV data broadcast scheme. This method uses downstream channels in the digital TV data broadcast system to transport the upgrading files, which can address the issues in the prior art to some extents. In this new method, downloading indication data is set in a memory of the terminal device to reminder the users of downloading files so as to upgrade the software upon the next power-on of the TV receiving terminal. According to this method, the users should set the downloading indication data so as to download the latest version of the upgrading files. Since the upgrading is determined by the users, it is inconvenient for the terminals' manufacturer to compulsively upgrade the software, manage and maintain the receiving terminal so as to address technical issues incurred or providing new services for the users. In addition, since the data broadcast provided by the terminals' manufacturer is not generally transmitted all day and all night, a user has to carry out the upgrading only in the next broadcast, if he/she misses the current broadcast due to the failure of setting the updating indication data. In this case, if the program for downloading the files don't work well in the receiving terminal such that the user fails to the upgrading indication data, the terminal cannot be upgraded forever, which is inconvenient for the terminals' manufacturer to manage and maintain the terminals. Furthermore, this method fails to take the charged software/data upgrade services into account, which is a disadvantage to the interests of the terminals' manufacturer.

### SUMMARY OF THE INVENTION

The present invention aims to provide a method for upgrading software or contents in a terminal device based on a digital TV data broadcasting so as to reduce the costs for maintaining the terminal device. The method not only facilitates the users to upgrade system timely and conveniently but also ensures the copyright benefit of the service provider.

In an explanatory embodiment of the present invention, there is disclosed a method for upgrading software or contents in a terminal device based on a digital TV data broadcasting comprising:

uploading an upgrading file or content file to an access gateway by a service provider via a data broadcasting system;

transmitting the upgrading file or content file to the terminal device in a broadcast mode by the data broadcasting system; and

receiving the transmitted upgrading file or content file by the terminal device.

The method further comprises steps of:

determining whether an identifier of the upgrading file or content file is identical with that of the terminal device; and

determining whether the received upgrading file or content file is of a higher version than that currently used in the terminal device; if yes, upgrading the currently used software file or content file in the terminal device.

Prior to the step of uploading the upgrading file or content file to the access gateway, the method further comprises steps of generating a file digital abstract and a digital signature from the upgrading file or content file by using a digital certificate.

The method further comprises:

generating a terminal digital abstract from the received upgrading file or content file by using the digital certificate;

comparing the terminal digital abstract with the file digital abstract to determine whether the received upgrading file or content file is compatible with the terminal device.

The digital signature is generated by encrypting the digital abstract with a public key of the digital certificate.

Alternatively, the digital signature is generated by encrypting the upgrading file or content file with a private key of the digital certificate, generating the digital abstract from the encrypted upgrading file or content file, and then encrypting the digital abstract with a public key of the digital certificate.

The above-mentioned solutions may decrease the costs for upgrading the software in the terminal device, facilitate to reinforce digital copyright protections, maintain benefits of the service provider (including terminal manufacturers and content providers). Moreover, the solutions facilitate the user to auto-upgrade the software running in the terminal device. Therefore, the above-mentioned solutions may bring better economic benefits.

### BRIEF DESCRIPTION OF THE DRAWING

FIG. 1 is a schematic diagram showing a structure of a digital TV transmitting/receiving terminal in the prior art;

FIG. 2 is a schematic diagram showing a structure of a digital TV system network according to the present invention;

FIG. 3 is a flow chart showing an operation process of a terminal device according to the present invention; and

FIG. 4 is a flow chart showing a process of upgrading files according to the present invention.

### DETAILED DESCRIPTION OF THE INVENTION

The present invention mainly refers to the upgrading of software files or content files in a TV receiving terminal by using a downstream channel for a data broadcasting system and an upstream channel for a telecom network or internet, combined with an asymmetric data encryption. The software files or content files comprise system software, application software, software data, media data and/or content data and so on.

The present invention will hereinafter be described in conjunction with the preferred exemplary embodiments shown in the appended drawings.

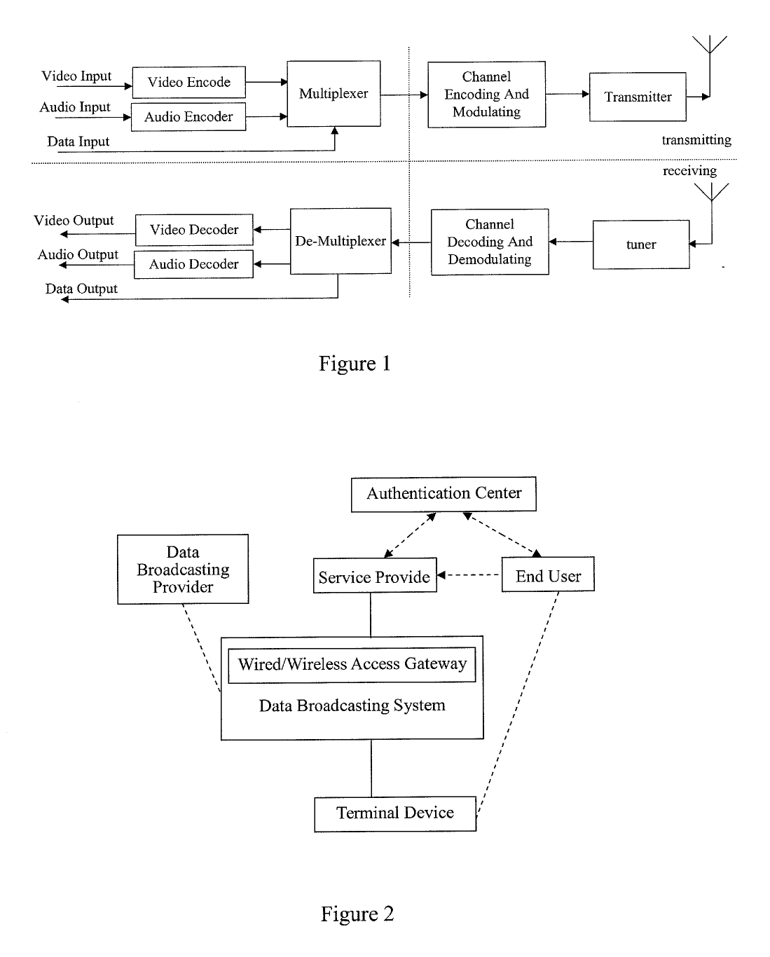

As shown in FIG. 2, data access services of a data broadcasting system are controlled by a data broadcasting provider, and digital TV terminal devices are supplied by a terminal device manufacturer. In the present example, the terminal device manufacturer or a content provider or a service provider, after being authorized or permitted by the data broadcasting provider, can transmit a upgrading file in a broadcast manner by using the data broadcasting system, via an access gateway of the data broadcasting provider. Hereinafter, the terminal device manufacturer, the content provider and the service provider are referred to the “service provider”.

The digital TV terminal device is such a terminal device that is provided by the terminal device manufacturer and used for receiving digital TV signals. This terminal device is not limited to a digital TV receiver, a digital TV receiving set-top box, an in-vehicle TV receiver, a portable TV receiver for receiving digital TV signals. This terminal device can also be a portable storage device, a program recording device, an audio/video play device, a GPS navigation device, a game device, etc. All the above-mentioned devices are referred to the “terminal device”.

The terminal device at least includes a control unit for controlling the upgrade of software or contents, a storage unit for storing the upgrading files or content files, and a receiving unit for receiving the upgrading files or content files.

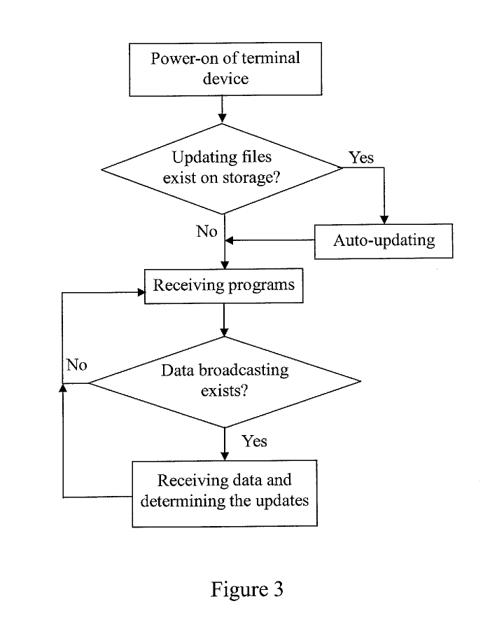

Referring to FIG. 3, an operation flow chart of the terminal device is shown. The processing for upgrading software files in the TV receiving terminal device based on a digital TV data broadcast is as follows:

uploading an upgrading file to the access gateway by the service provider via the data broadcasting system, and transmitting the upgrading file to the terminal device in a broadcast manner via the data broadcasting system;

receiving the upgrading file by the terminal device; and

determining whether the received upgrading file is of a higher version than that of the currently used software of the terminal device; if yes, upgrading the currently used software in the terminal device.

The above processing also includes a step of determining, by the terminal device, whether the upgrading file is compatible with the terminal device after the upgrading file is received, and preferably includes a step of determining whether an identifier of the upgrading file is consistent with that of the terminal device. The identifier of the upgrading file may be, but not limited to, the identifier for indicating the length of the information, length of the file, ID of the carrier or ID of products added to the head or end of the file. The identifier of the terminal device may be pre-defined or pre-allocated by the service provider.

The present example also comprises an process for upgrading the content file in the TV receiving terminal based on a digital TV data broadcast:

uploading the content file to the access gateway by the service provider via the data broadcasting system, and transmitting the content file to the terminal device in a broadcast manner via the data broadcasting system; and

receiving the content file by the terminal device.

The received upgrading file or content file can be directly called or executed, or alternatively, be stored in a storage unit. The terminal device can check the stored upgrading file or content file when being turned on, and call or execute the upgrading file or content file to complete the upgrade process.

The above processing can also include a step of determining whether the received content file is of a higher version than that of a currently used software in the terminal device; if yes, upgrading the currently used software. The upgrade process can be a step of substituting or overwriting the currently used file with the received content file.

The above process may also include a step of determining whether the content file is compatible with the terminal device after the content file is received by the terminal device, and preferably includes a step of determining whether an identifier of the content file is consistent with that of the terminal device. The identifier of the content file may be, but not limited to, the identifier for indicating the length of the information, length of the file, ID of the carrier or ID of products added to the head or end of the file. The identifier of the terminal device may be pre-defined or pre-allocated by the service provider.

In order to ensure that only the specified terminal device can receive and use the upgrading file or content file provided by the service provider to protect the copyright or other lawful rights and interests of the service provider, a second example according to the present invention uses a digital certificate to identify the terminal device.

In the second example, the service provider or a user of the terminal device requests an authentication center for the respective digital certificate. The digital certificate requested by the service provider can be used for identifying a plurality of terminal devices in its service range and be preset or stored in the plurality of terminal devices by the service provider, while the digital certificate requested by the user can be used for identifying the terminal device held by the user and be preset or stored in the terminal device by the user. The service provider supplies the upgrading file or content file to the terminal device held by a user according to the digital certificate requested by this user.

The authentication center is a third-party service provider for security authentication of electronic information and responsible for supplying information security solution of digital certificate application technique.

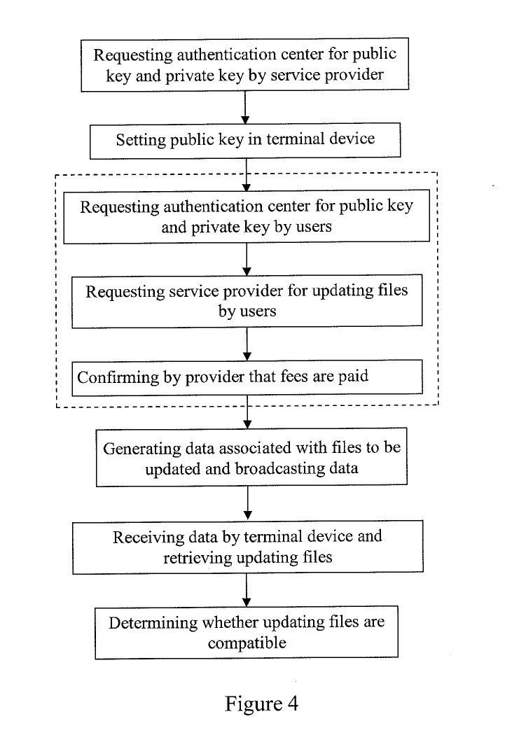

Referring to FIG. 4, a process for upgrading software of the TV receiving terminal device based on a digital TV data broadcast according to the present example is as follows:

encrypting the upgrading file by using a digital certificate so as to generate a file digital abstract and a digital signature by a service provider;

uploading the upgrading file and the digital signature to the access gateway by a service provider via a data broadcasting system, and transmitting the upgrading file and the digital signature to the terminal device in a broadcast manner via the data broadcasting system;

receiving the transmitted upgrading file and the digital signature by the terminal device;

decrypting the received digital signature by using a pre-stored digital certificate by the terminal device so as to generate the file digital abstract;

encrypting the received upgrading file by using a digital certificate by the terminal device so as to generate a terminal digital abstract;

comparing the terminal digital abstract with the file digital abstract so as to determine whether the received upgrading file is compatible with the terminal device;

if it is yes, determining the received upgrading file is of a higher version than that of the currently used file of the terminal device; and if yes, upgrading the currently used file of the terminal device.

The present example further includes a process for upgrading contents of a TV receiving terminal based on digital TV data broadcasting, comprising:

encrypting the content file by using a digital certificate so as to generate a file digital abstract and a digital signature by a service provider;

uploading the content file and the digital signature to the access gateway by a service provider via a data broadcasting system;

transmitting the content file and the digital signature to the terminal device in a broadcast manner by the data broadcasting system; and

receiving the transmitted content file and the digital signature by the terminal device;

decrypting the received digital signature by using a pre-stored digital certificate by the terminal device so as to generate the file digital abstract;

encrypting the received content file by using a digital certificate by the terminal device so as to generate a terminal digital abstract;

comparing the terminal digital abstract with the file digital abstract so as to determine whether the received content file is compatible with the terminal device, and if it is yes, storing or calling the content file.

The service provider requests the authentication center for the digital certificate so as to obtain a public key, a private key and a public key of the private key. The private key is used for encrypting the digital abstract to generate the digital signature after the service provider processes the updating file (including updating software, system software, free software or data) or content file by using a promissory algorithm to generate the digital abstract. The public key is pre-embedded or pre-stored in the terminal device so that the terminal device can decrypt the received digital signature to obtain the file digital abstract and encrypt the received updating software or content file to generate the terminal digital abstract.

The terminal user requests the authentication center for the digital certificate to obtain the public key and private key for the user. The public key for the user is provided to the service provider by the terminal user so that the service provider can encrypt the updating file (including updating software, system software, free software or data) or content file to generate an encrypted updating file or encrypted content file. The encrypted updating file or encrypted content file can be only decrypted by the private key for the user. The private key for the user is pre-embedded or pre-stored in the terminal device so that the terminal device can decrypt the received encrypted updating file or encrypted content file to obtain the updating file or content file.

The public key and private key are two ciphertexts which are matched with each other and generated by the RSA system, Diffle-Hellman or other algorithms. It is ensured that the encrypted data can be only decrypted by the corresponding private key.

Further, it is ensured by encrypting the data with the public key that once any bit of the encrypted data and the public key is changed, the re-computed digital abstract will be inconsistent with the original one, so that the data is ensured to be unchangeable and complete.

In the above-mentioned process, if the updating file or content file is initiatively transmitted to the terminal device by the service provider in a broadcast manner, it is unnecessary to encrypt the updating file or content file, and the digital abstract is generated based on the updating file or content file and encrypted with the public key. If the updating file or content file is demanded or ordered by the terminal user from the service provider, the public key for user should be provided to the service provider. Then, the service provider encrypts the updating file or content file by using the public key to generate the encrypted updating file or encrypted content file, generate the digital abstract based on the encrypted updating file or encrypted content file, and then encrypt the digital abstract by using the public key.

The terminal user may request the updating file or content file demanded or ordered from the service provider via a telecommunication network, Internet, mobile network or data broadcasting system and any combination thereof.

In the present example, the terminal user could demand or order the desired updating file or content file with a payment. Therefore, after the service provider receives the demanding or ordering request from the terminal user, the service provider will check the request to validate the identification of user and/or determine whether the user has already made the payment, so as to determine whether to send the updating file or content file or not. If it is determine that the user is a valid one, there exit the requested updating file or content file and the payment has already been made, the process for upgrading software or contents of a TV receiving terminal based on the digital TV data broadcasting is performed.

The promissory algorithm may be MD2, MD4, MD5, SHA, SHA-1, SHA-2 256, SHA-2 384, SHA-2 512, RIPEMD-160 and so on. Since the above-mentioned algorithms are well-known in the art, the detailed descriptions thereon are omitted.

In the present example, the service provider may add an identifier with a particular specification to the updating file or content file demanded or ordered by the user so as to determine whether the updating file or content file is exactly the one demanded or ordered by the user.

After the updating file or content file is received by the terminal device, it is determined whether the identifier added to the upgrading file or content file is identical with that of the terminal device. The identifier added to the upgrading file or content file may be, but not limited to, the identifier for indicating the length of the information, length of the file, ID of the carrier or ID of products added to the head or end of the file. The identifier may be pre-defined or pre-allocated by the service provider.

The data broadcasting or transmitting methods in each of the examples may be based on the DSM-CC data broadcasting protocols specified by the existing ISO/IEC 13818-6. Since the data broadcasting or transmitting methods are well-known and widely used in the art, the detailed descriptions thereon are omitted. The scope of the present invention will cover all the equivalents based on the concept of the present invention and the examples described in the specification.

1. A method for upgrading software or contents in a terminal device based on a digital TV data broadcasting, comprising:
uploading an upgrading file or content file to an access gateway by a service provider via a data broadcasting system;
transmitting the upgrading file or content file to the terminal device in a broadcast mode by the data broadcasting system; and
receiving the transmitted upgrading file or content file by the terminal device.

2. The method according to claim 1, further comprising:
determining whether the received upgrading file or content file is of a higher version than that of a currently used software file or content file in the terminal device; and
upgrading the currently used software file or content file, if the received upgrading file or content file is of a higher version.

3. The method according to claim 1, further comprising:
determining whether an identifier of the upgrading file or content file is identical with that of the terminal device.

4. The method according to claim 1, further comprising:
generating a file digital abstract and a digital signature from the upgrading file or content file by using a digital certificate, prior to the step of uploading the upgrading file or content file to the access gateway.

5. The method according to claim 4, further comprising:
generating a terminal digital abstract from the received upgrading file or content file by using the digital certificate; and
comparing the terminal digital abstract with the file digital abstract to determine whether the received upgrading file or content file is compatible with the terminal device.

6. The method according to claim 4, wherein the digital signature is generated by encrypting the digital abstract with a public key of the digital certificate.

7. The method according to claim 4, wherein the digital signature is generated by encrypting the upgrading file or content file with a private key of the digital certificate, generating the digital abstract from the encrypted upgrading file or content file, and then encrypting the digital abstract with a public key of the digital certificate.

8. The method according to claim 5, wherein the digital certificate is obtained by a requisition, or pre-set or pre-stored in the terminal device.

9. The method according to claim 1, wherein the service provider accepts a request for demanding or ordering the upgrading file or content file and transmits the upgrading file or content file based on the request.

10. The method according to claim 9, further comprising:
verifying contents of the request, a validity of the request and/or a payment for the request by the service provider and determining whether the upgrading file or content file is to be transmitted based on the verifying, prior to the step of uploading the upgrading file or content file to the access gateway.

11. The method according to claim 2, further comprising:
generating a file digital abstract and a digital signature from the upgrading file or content file by using a digital certificate, prior to the step of uploading the upgrading file or content file to the access gateway.

12. The method according to claim 3, further comprising:
generating a file digital abstract and a digital signature from the upgrading file or content file by using a digital certificate, prior to the step of uploading the upgrading file or content file to the access gateway.

13. The method according to claim 11, further comprising:
generating a terminal digital abstract from the received upgrading file or content file by using the digital certificate; and
comparing the terminal digital abstract with the file digital abstract to determine whether the received upgrading file or content file is compatible with the terminal device.

14. The method according to claim 12, further comprising:
generating a terminal digital abstract from the received upgrading file or content file by using the digital certificate; and
comparing the terminal digital abstract with the file digital abstract to determine whether the received upgrading file or content file is compatible with the terminal device.

15. The method according to claim 11, wherein the digital signature is generated by encrypting the digital abstract with a public key of the digital certificate.

16. The method according to claim 12, wherein the digital signature is generated by encrypting the digital abstract with a public key of the digital certificate.

17. The method according to claim 11, wherein the digital signature is generated by encrypting the upgrading file or content file with a private key of the digital certificate, generating the digital abstract from the encrypted upgrading file or content file, and then encrypting the digital abstract with a public key of the digital certificate.

18. The method according to claim 12, wherein the digital signature is generated by encrypting the upgrading file or content file with a private key of the digital certificate, generating the digital abstract from the encrypted upgrading file or content file, and then encrypting the digital abstract with a public key of the digital certificate.

19. The method according to claim 11, wherein the digital certificate is obtained by a requisition, or pre-set or pre-stored in the terminal device.

20. The method according to claim 12, wherein the digital certificate is obtained by a requisition, or pre-set or pre-stored in the terminal device.

21. The method according to claim 2, wherein the service provider accepts a request for demanding or ordering the upgrading file or content file and transmits the upgrading file or content file based on the request.

22. The method according to claim 4, wherein the service provider accepts a request for demanding or ordering the upgrading file or content file and transmits the upgrading file or content file based on the request.

23. The method according to claim 11, wherein the service provider accepts a request for demanding or ordering the upgrading file or content file and transmits the upgrading file or content file based on the request.

24. The method according to claim 12, wherein the service provider accepts a request for demanding or ordering the upgrading file or content file and transmits the upgrading file or content file based on the request.
